(19) United States
(12) Patent Application Publication
(10) Pub. No.: US 2006/0226769 A1
(43) Pub. Date: Oct. 12, 2006

(54) Display device

(75) Inventor: Masaru Kinoshita, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/384,403

(22) Filed: Mar. 21, 2006

(30) Foreign Application Priority Data
Mar. 22, 2005 (JP) 2005-81304

(51) Int. Cl. H01J 1/62

(52) U.S. Cl. 313/504

(57) ABSTRACT

The present invention provides a novel display device having simple configuration, thin profile and high quality. The display device of the present invention includes a luminescent section formed by laminating two or more individually light-emitting organic electroluminescent elements, and a shutter section. The shutter section may be a liquid crystal shutter element. The organic electroluminescent element is preferably driven by a field sequential system.

### CROSS-REFERENCE TO RELATED APPLICATION

This application claims priority under 35USC119 from Japanese Patent Application No. 2005-81304, the disclosure of which is incorporated by reference herein.

### BACKGROUND OF THE INVENTION

1. Field of the Invention

The present invention relates to a display device that uses an organic electroluminescent element (hereinafter, “organic EL element”) as the backlight.

2. Description of the Related Art

An organic EL element which has organic thin layers each having hole transport property and electron transport property are laminated has been reported (see, for example, C. W. Tang and S. A. Vanslyke, Applied Physics Letters, Vol. 51, p. 913, 1987). Since then, then organic EL element has been expected to be applied to a flat panel display as a large-area luminescent element capable of emitting light by applying low voltages of not more than 10 V and responding quickly.

Generally, a laminated organic EL element is structured by laminating a positive electrode, a hole transport layer, a luminescent layer, an electron transport layer, and a negative electrode. The luminescent layer may be incorporated in the hole transport layer or the electron transport layer as a two-layered element described in the above document. In addition to a single layer formed by a single material, a dye-doped layer is proposed as a luminescent layer in order to obtain an organic EL element with high luminescent efficiency. In the dye-doped layer, a small amount of dye molecules with high fluorescent emitting efficiency is doped into a host material which is a major constituent (see, for example, C. W. Tang and S. A. Vanslyke, Applied Physics Letters, Vol. 65, p. 3610, 1989).

With recent development in materials and optimization of element structure, luminous efficiency and device life of organic EL elements have been improved significantly. Therefore, organic EL elements began to be practically applied to displays with multiple colors in different areas (area color panels) and full-color panels. Further, taking advantage of such features of the organic EL element as thin, lightweight and uniform emission across a large area, it has been attempted to apply the organic EL element to illuminating equipment.

In application to a flat panel display, taking advantage of such features of the organic EL element as thin, lightweight and uniform emission across a large area, it has been studied to apply organic EL elements to a display device in which a luminescent section formed by laminating organic EL elements is used in a backlight, and liquid crystal shutter elements are used in a shutter section. Especially, attentions are focused on organic EL elements in mobile devices required to be thin and lightweight.

As an approach to improve luminance and definition of display devices, a liquid crystal display device which employs, in place of a conventional color filter process that displays colors by spatially separating displayed colors, a field sequential system that displays colors by temporally separating displayed colors, have been developed. In a field sequential liquid crystal display device, colors are displayed through synchronization of monochrome surface emission of red (R), green (G) and blue (B) and switching of a liquid crystal panel so as to display image data of R, G and B in a temporally separated manner. Thus, a backlight used in such a field sequential liquid crystal display device is required to switch emission of R, G and B quickly. It has been attempted to employ an organic EL element of fast response as the backlight.

As a specific example, to have R, G and B to emit separately, it has been proposed to pattern the R, G and B devices on the same surface (see, for example, claims of Japanese Patent Application Laid-Open (JP-A) No. 2002-55324). However, in this structure, the pattern pitch of R, G and B devices in the backlight should be shorter than 1 dot (ideally, one or more sets of R, G and B devices for each dot) so that the light transmitted through 1 dot of the liquid crystal device section has sufficiently mixed R, G and B. Thus, such a structure sometimes has difficulty in manufacture. A method of providing a light-diffusion layer and the like between a liquid crystal device section and the backlight made from organic EL elements to obtain mixed R, G and B has been proposed (see, for example, claims of JP-A No. 2000-241811, and No. 2001-290146). In these approaches, however, the manufacturing cost increases and the display device becomes thick.

### SUMMARY OF THE INVENTION

According to one aspect of the presents invention, a display device is provided which includes a luminescent section formed by laminating two or more organic electroluminescent elements that individually emit light, and a shutter section. The present invention provides a novel display device.

### BRIEF DESCRIPTION OF THE DRAWINGS

FIG. 1 is a schematic cross-sectional view of a conventional field sequential liquid crystal display device with a backlight of organic EL elements;

FIG. 2 is a schematic cross-sectional view of a liquid crystal display device according to the invention;

FIGS. 3A to 3G are schematic plan views of a luminescent section of a liquid crystal display device seen from a cathode side, in the manufacturing process thereof according to the invention;

FIG. 4 illustrates a co-deposition process of 2-TNATA and F4-TCNQ; and

FIG. 5 is another schematic cross-sectional view of a liquid crystal display device according to the invention.

### DETAILED DESCRIPTION OF THE INVENTION

An object of the invention is to provide a novel display device which overcomes above-described problems. Further objects and advantages of the invention will be apparent from the following description.

Embodiments of the invention will be described with reference to drawings, examples and the like. These drawings, examples and the like, and the description of the invention are illustrative only and not to limit the scope of the invention. Variations of the described embodiments are intended to be within the scope of the invention without departing from the spirit and scope of the invention. In the drawings, the same reference numerals denote the same components.

Now, the invention will be described with respect to a liquid crystal display device employing an organic EL element as a backlight. However, the invention will not be limited thereto. Rather, the invention can be broadly applied to display devices which comprise a luminescent section using organic EL elements and a shutter section that transmit or block light. From such a point of view, the liquid crystal display device employing organic EL elements as the backlight according to the invention is structured to include a luminescent section using organic EL elements and a shutter section made of liquid crystal shutter devices. The liquid crystal shutter device herein is a device which transmits and blocks light by a switching function of liquid crystal. The liquid crystal shutter device corresponds to a conventional liquid crystal display device without the backlight.

The display device according to the invention includes a luminescent section formed by laminating two or more organic electroluminescent elements that individually emit light, and a shutter section.

A novel display device can be realized with the structure described above. The display device provides simple configuration, thin profile or high quality. In particular, because the luminescent section can provide color lights such as red, green and blue when it serves as a backlight of a conventional liquid crystal display element, a conventional color filter is not necessary. Accordingly, the structure can be simplified and made thinner. The organic EL element may provide displayed images having higher brightness and color purity as compared to conventional liquid crystal display elements. In addition, reduced brightness suppresses element degradation, and provides a long-life backlight. A liquid crystal shutter element is used to provide images of higher definition as compared to images displayed only by organic EL elements, because the definition of displayed image depends only on the definition of the liquid crystal shutter element and not on the definition of the organic EL element which has difficulty in making the definition higher.

The shutter section is preferably a liquid crystal shutter elements. As to organic EL element, two or more organic EL elements that individually emit light may simultaneously emit light and the mixed light (typically, white light) may be used. However, a field sequential system is preferably used for driving in which two or more organic EL elements, which individually emit light, dividedly emit light so that emitted light does not at least partially overlap. In this manner, various colors including white can be displayed without using color filters by the temporally divided luminescence.

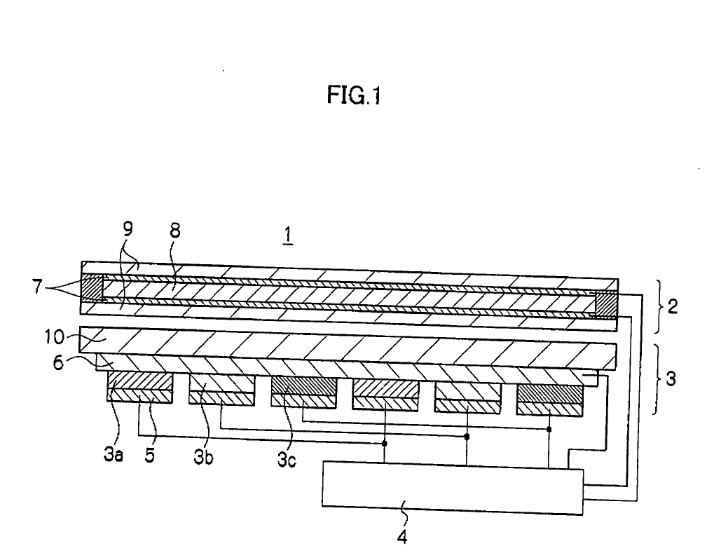

Next, the configuration of the display device according to the present invention will be described in detail with reference to a liquid crystal display device in which organic EL elements are used as backlights. FIG. 1 is a schematic cross-sectional view of an example of a conventional field sequential liquid crystal display device in which organic EL elements are used as backlights. The field sequential liquid crystal display device 1 is structured by a liquid crystal shutter element (shutter section) 2, an organic EL element (luminescent section) 3 and a driving section 4.

The shutter section 2 is formed by a liquid crystal layer 8 sandwiched between a pair of transparent substrates 9. The liquid crystal layer 8 is disposed between transparent electrodes 7.

The structure of the luminescent section 3 is, on a transparent substrate 10, a layer having each luminescent element (3a, 3b and 3c) for R, G and B patterned thereon is provided between a cathode 5 and an anode 6. The organic EL element 3 includes a hole transport layer, a luminescent layer, and an electron transport layer (not shown). When the voltage is applied between the cathode 5 and the anode 6, the electrons are transported from the cathode 5 via the electron transport layer to the luminescent layer while holes are transported from the anode 6 via the bole transport layer to the luminescent layer. The electrons and the holes are re-combined at the luminescent layer to provide luminescence. The emitted light is made to transmit the anode 6 and the transparent substrate 4 to the liquid crystal shutter element 2, where an image is displayed by the switching function of the liquid crystal.

In such a structure, in order to suppress unevenness in the mixed R, G and B colors of the light transmitting the liquid crystal shutter elements, the light transmitted through 1 dot of the liquid crystal device section 2 is required to have sufficiently mixed R, G and B. For example, it is necessary to set the pattern pitch of the R, G and B of the organic EL elements of the backlight to the size or smaller of 1 pixel opening of the liquid crystal shutter element (ideally, one or more sets of R, G and B pattern are within the size of the opening) (two sets are disposed in FIG. 1). However, conventional patterning technology of deposition using a shadow mask has a limit involved in the pattern pitch and thus is disadvantageous in making the high definition liquid crystal display device.

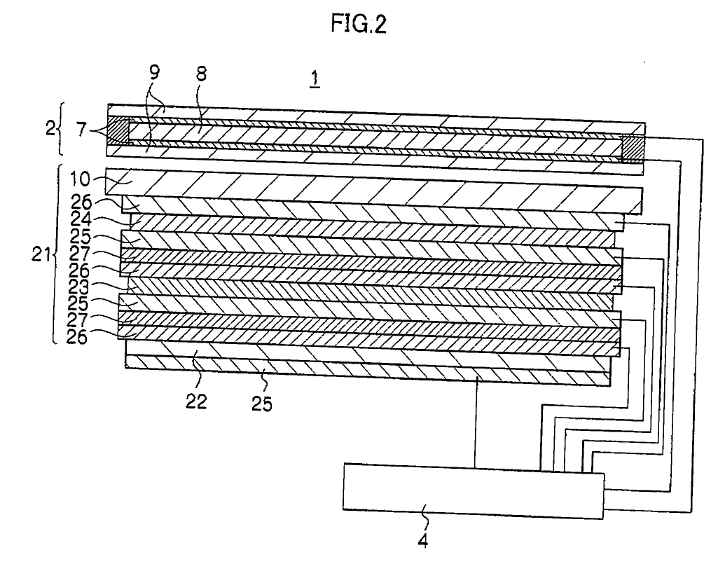

FIG. 2 is a schematic sectional view of a liquid crystal display device according to the invention. In FIG. 2, the luminescent section 21 used in the backlight is structured by organic EL elements 22, 23 and 24 for R, G and B laminated in this order onto the transparent substrate. In this structure, organic EL elements for R, G and B are not necessarily patterned on the same surface. Thus, the structure of liquid crystal display device according to the invention is simple so that it is advantageous in producing high definition liquid crystal display device. In addition, a large luminescent area for each of the organic EL elements 22, 23 and 24 for R, G and B can be obtained, the brightness for each of the elements per unit area can be reduced. Thus, element degradation can be suppressed and a long-life backlight can be obtained. The number of the organic EL elements is not limited, but three, in particular, R, G and B is preferable.

The unit of displayed image (i.e., pixel) is defined by the opening are of the liquid crystal shutter element. The displayed color is defined by recognition (mixing color) of human eyes temporally mixing the emitted colors of each organic EL element. Therefore, each organic EL element may be arranged in a dotted pattern or a striped pattern, but it is not necessary to be thus arranged, and it can be arranged in a simple planar shape. Accordingly, the structure can be significantly simplified.

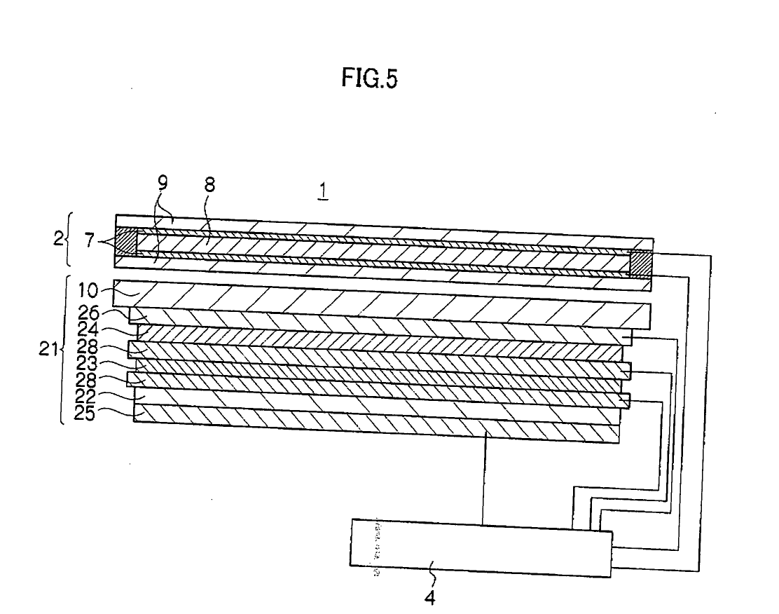

Configurations of individual organic EL element and the method of producing the same are not limited and known configurations and methods can be employed. In the method of producing the organic EL element, as shown in FIG. 2, the cathode 25 and the anode 26 may be disposed for each of the organic EL elements, but in this case, it is required to provide a transparent insulating layer 27 between the cathode 25 and the anode 26. Alternatively, as shown in FIG. 5, an upper electrode of an organic EL element also serves as a lower electrode of the organic EL element directly therebelow. Such an electrode serving either as upper or lower electrode is herein referred to as an intermediate electrode. The intermediate electrode is denoted by reference numeral 28 in FIG. 5.

In the display device according to the invention, it is only necessary that if one of the upper and lower electrodes is an anode, then the other is a cathode. Thus, if an upper electrode of a certain organic EL element A also serves as a lower electrode of an organic EL element B, i.e., the electrode is an intermediate electrode, the intermediate electrode can be fixedly treated as an anode by setting both of the lower electrode of the organic EL element A and the upper electrode of the organic EL element B to cathodes. On the other hand, if a lower electrode of the organic EL element A also serves as an upper electrode of the organic EL element B, i.e., the electrode is an intermediate electrode, the intermediate can be fixedly treated as a cathode by setting both of the lower electrode of the organic EL element A and the upper electrode of an organic EL element B to anodes.

In a case in which the lower electrode of the organic EL element A is a cathode and the upper electrode of the organic EL element B is an anode, and in which the lower electrode of the organic EL element A is an anode and the upper electrode of the organic EL element B is a cathode, the intermediate electrode can be used as an anode where the positive potential is loaded and as a cathode where the negative potential is loaded by making the intermediate electrode temporally switched between positive and negative potentials. If the organic EL element is structured with three or more layers, as shown in FIG. 5, the upper and lower electrodes of the intermediate organic EL element can be structured such that both of the upper and lower electrodes are intermediate electrodes that are temporally switched between positive and negative potentials. These structures may be employed for the intermediate electrode according to the invention, but a structure in which the intermediate electrode is switched between positive and negative potentials is preferable in the view of a simple structure of the organic EL element.

The order of laminating R, G and B layers is not particularly limited. However, if it is possible that the light emitted from a lower layer is absorbed by an upper layer, or an effect of light interference exists, the order of laminating should be determined considering these factors.

The luminescent period of the organic EL element may be determined depending on desired color development. A plurality of organic EL elements may emit light during the same period. When the effect of color mixing is to be exhibited by emitting light through temporal division, the luminescent period of each of the organic EL elements is not necessarily the same, and may be different among elements, which is effective. For example, when the red and blue lights are to be emitted though temporal division, more bluish color mixing can be produced by setting the luminescent period of the blue to be longer than that of the red.

The luminescent period (i.e., a subframe period) of each of the organic EL elements is not particularly limited. However, 1/150 to 1/300 seconds is generally preferable.

When such an organic EL element is used in a luminescent section, the size of the element typically becomes large. In such a situation, wiring resistance of the transparent substrate (generally, an ITO substrate) used as each electrode sometimes cannot be ignored That is, though transparent electrodes such as ITO are electrically conductive, they have certain electrical resistance, and thus brightness distribution caused by voltage drop of the transparent electrode often occurs. In particular, brightness is high near power supply bus but is sometimes low near areas remote from the power supply bus (for example, display center portion).

In such a case, it is effective to provide auxiliary electrodes at at least one of outside of a luminescent area, inside of a luminescent area, and a boundary thereof This can avoid a problem that the brightness decreases at areas remote from the power supply bus. Such a structure is desired, but is not necessary, for all of organic EL elements. The auxiliary electrode is made from materials having electrical resistance smaller than that of the transparent electrode. For example, metals such as Cu, Au and Ag can be used. These metals do not easily transmit light, thus in general the auxiliary electrodes are preferably provided outside of the luminescent area or at boundaries of outside and inside of the luminescent area of the organic EL element.

In order to control brightness distribution, it is also effective to set local voltage-brightness characteristics of the organic EL element to change toward the inner surface direction to make brightness within the surface uniform.

To obtain such effects, it is important that the layer thickness of the organic EL element in the inner surface direction is substantially uniform. The uniform layer thickness helps prevent unevenness in chromaticity due to light interference inside the organic EL element. The substantially uniform layer thickness includes variations in thickness generated by performance limit of the layer-making device. Typically, the layer thickness can be considered substantially uniform when the difference between the maximum thickness and the minimum thickness is not greater than 5%.

When the layer thickness of the organic EL element in the inner surface direction is substantially uniform, brightness distribution can be controlled by having the local voltage-brightness characteristics of the organic EL element changed toward the inner surface direction, and making brightness within the surface uniform. The fact that the brightness in the surface becomes uniform can be confirmed by the fact that the brightness in the surface is made more uniform as a result of changed local voltage-brightness characteristics of the organic EL element in the inner surface direction than a case where the method is not taken (for example, the difference between the brightness of the central portion and the brightness of the outer peripheral portion becomes smaller). The local voltage-brightness characteristics of the organic EL element can be changed toward the inner surface direction in any method without deviation of the scope do the invention. For example, the methods described below may be employed.

Method 1

It is known to dope an acceptor molecule into a hole transport layer in order to measure lowering of the voltage of the organic EL element (see, for example, Zhou et al., Applied Physics Letters, Vol. 78, p. 410, 2001). The distribution in the surface is given to the doped amount.

Method 2

It is known to dope low work function metal such as Li into a hole transport layer in order to measure lowering of the voltage of the organic EL element (see, for example, J. Kido and T. Matsumoto, Applied Physics Letters, Vol. 73, p. 2866, 1998). The distribution in the surface is given to the doped amount.

With the structure described above, the manufacturing process can be simplified as compared to a field sequential liquid crystal display device which uses conventional organic EL elements as the backlight. A thin, high quality and free from uneven color and brightness distribution can be realized. In addition, the brightness for each of the elements per unit area can be reduced in order to obtain uniform brightness as a backlight. Thus, element degradation can be suppressed and a long-life backlight can be provided.

Taking advantage of such features of the organic EL element as thin, lightweight and uniform emission across a large area, the invention can be appropriately applied to liquid crystal display devices. In particular, the invention is preferable in mobile devices requiring thinness and lightweight.

### EXAMPLES

Examples and Comparative Examples of the invention will be described below.

### EXAMPLE 1

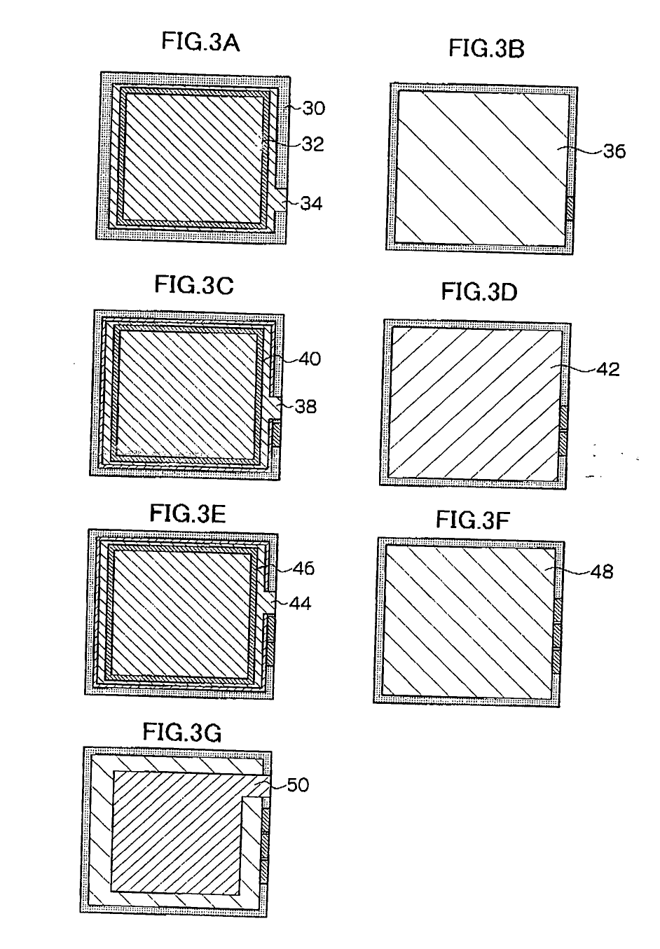

A luminescent section as a backlight for a field sequential liquid crystal display device was manufactured in the following manner. In the luminescent section, organic EL elements of R, G and B having a luminescent area of 13 cm×15 cm were laminated. FIGS. 3A to 3G illustrate the manufacturing process in plan views seen from the cathode side.

ITO was sputtered onto a glass substrate 30 via a shadow mask for an anode to form a anode 34 of predetermined pattern. The layer thickness of the ITO was 200 nm and the sheet resistance was 15 Ω/□. Then, Al was deposited onto the ITO as an auxiliary electrode 32 through vacuum deposition via a shadow mask for an auxiliary electrode to a thickness of 100 nm (see FIG. 3A). In this example, the auxiliary electrode 32 was provided at the boundary of the outside and the inside of the luminescent area. If there is no other problem, the auxiliary electrode 32 may be provided inside of the luminescent area across the anode surface.

Then, red-emitting organic EL element 36 was formed as a layer through vacuum deposition via a shadow mask for an organic EL element (see FIG. 3B). The red-emitting organic EL element 36 was formed by a plurality of layers: a hole injecting layer, a hole transport layer, a red-emitting layer, an electron transport layer and an electron injecting layer in this order from the ITO side. The hole injecting layer was made of 2TNATA(4, 4′, 4″ -tris(2-naphthylphenylamino)triphenylamine) having a thickness of 140 nm. The hole transport layer 16 was made of α-NPD(N, N′-dinaphthyl-N, N′-diphenyl-(1, 1′-biphenyl) -4, 4′-diamine) having a thickness of 10 nm. The red-emitting layer was formed by simultaneously depositing DCJTB(4-(Dicyanomethylene)-2-t-butyl-6-(1,1,7,7-tetramethyljulolidyl-9-enyl)-4H-pyran) and Alq₃(tris(8-hydroxyquinolinato) aluminum) (deposition ratio-99 Alq₃ molecules for each DCJTB molecule) to a thickness of 20 nm. The electron transport layer 18 was made of Alq₃ having a thickness of 30 nm. The electron injecting material is lithium fluoride having a thickness of 0.5 nm. Al was deposited thereon to a thickness of 1.5 nm.

Subsequently, ITO was sputtered as a first intermediate electrode 38 via a shadow mask for a first intermediate electrode. Then, Al was sputtered as an auxiliary electrode 40 on the ITO via a shadow mask for an auxiliary electrode 40 to a thickness of 100 nm.

Then, green-emitting organic EL element 42 was formed as a layer via a shadow mask for an organic EL element (see FIG. 3D). The green-emitting organic EL element 42 was formed by a plurality of layers: a hole injecting layer, a hole transport layer, a green-emitting layer, an electron transport layer and an electron injecting layer in this order from the ITO side. The hole injecting layer was made of 2TNATA having a thickness of 140 nm. The hole transport layer was made of α-NPD having a thickness of 10 nm. The green-emitting layer was formed by simultaneously depositing t(npa)py(1, 3, 6, 8-tetra (N-(naphthyl)-N-phenylamino)pyrene and Alq₃ (deposition ratio: 99 Alq₃ molecules for each t(npa)py molecule) to a thickness of 20 nm. The electron transport layer was made of Alq₃ having a thickness of 30 nm. The electron injecting material was lithium fluoride having a thickness of 0.5 nm. Al was deposited thereonto a thickness of 1.5 nm.

Subsequently, ITO was sputtered as a second intermediate electrode 44 via a shadow mask for a second intermediate electrode 44. Then, Al was sputtered as an auxiliary electrode 46 on the ITO via a shadow mask for an auxiliary electrode 46 to a thickness of 100 nm (see FIG. 3E).

Then, blue-emitting organic EL element 48 was formed as a layer via a shadow mask for an organic EL element (see FIG. 3F). The blue-emitting organic EL element 48 is formed by a plurality of layers; a hole injecting layer, a hole transport layer, a blue-emitting layer, a hole blocking layer, a electron transport layer and an electron injecting layer in the order from the ITO. The hole injecting layer was made of 2TNATA having a thickness 140 nm. The hole transport layer was made of α-NPD having a thickness of 10 nm. The blue-emitting layer was formed by simultaneously depositing t(bp)py(1,3,6,8-tetrabiphenylpyrene) and CBP (4, 4′-bis(9-carbazolyl)-biphenyl) having a thickness of 20 nm (deposition ratio; 90 CBP molecules for each 10 t(bp)py molecules). The hole blocking layer was made of BAlq having a thickness of 10 nm. The electron transport layer was made of Alq₃ having a thickness of 20 nm. The electron injecting material was lithium fluoride having a thickness of 0.5 nm. Al was deposited thereon as a cathode 50 to a thickness of 100 nm via cathode mask (see FIG. 3G).

On the thus obtained emittor, a liquid crystal shutter element having a pixel pitch of 0.1 mm is disposed. The emittor and the liquid crystal shutter element are connected to a driving section and a white solid image is displayed by switching R, G and B emission at a frame frequency of 60 Hz (i.e., the subframe period for each of R, G and G is 1/180 seconds). The first and second intermediate electrodes were used by temporally switching positive potential and negative potential. The liquid crystal shutter device had a structure of a so-called liquid crystal display device without a backlight.

The whiteness was set such that the brightness balance of R, G and B was adjusted, the CIE chromaticity was (x, y)=(0.31, 0.32) at the center of the panel and the brightness was set to 200 cd/m². The CIE chromaticity and brightness were detected at a plurality of points in the panes, and it was found that uniform CIE chromaticity was obtained across the panel. The brightness increases from the center toward outer peripheral portion of the panel, and was 320 cd/M² at the outer peripheral portion.

The subframe period of each of the R, G and B within 1/60 seconds of the frame period was changed to control the color tint of the emitted light. In particular, the subframe period of R and G were 1/240 seconds, the subframe period of B was 1/120 seconds (twice as long as those of R and G). The CIE chromaticity at the center of the panel was detected as (x, y)=(0.25, 0.26) and the color was bluish white. In this manner, it was confirmed that the chromaticity can be controlled by changing the subframe period.

It was also confirmed that the color display can be freely displayed by changing the alignment condition of the liquid crystal molecules and changing the light transmittance according to R, G and B image signals.

### EXAMPLE 2

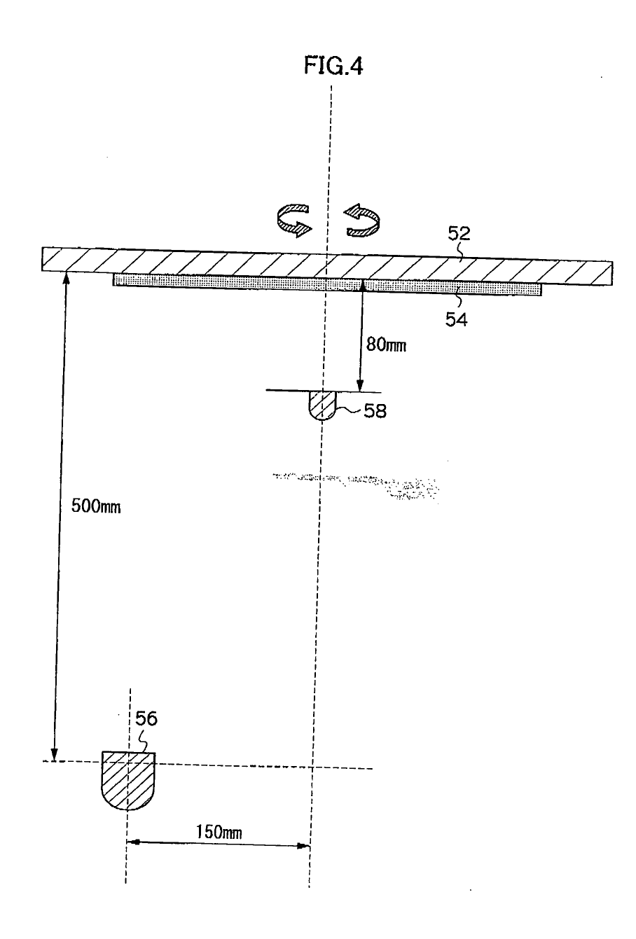

A luminescent section in which organic EL elements of R, G and B having a luminescent area of 13 cm×15 cm are laminated is manufactured as a backlight for a field sequential liquid crystal display device as in Example 1. In Example 2, the hole injecting layer (2-TNATA) for each of the luminescent elements of R, G and B was doped with F4-TCNQ(2, 3, 5, 6-tetrafluoro-7, 7, 8, 8,-tetracyanoquinodimethane) as an acceptor molecule. In particular, at the time of forming the layer of 2-TNATA, the 2-TNATA and the F4-TCNQ were co-repositioned. The deposition source 56 of 2-TNATA and the deposition source 58 of F4-TCNQ were positioned in the manner shown in FIG. 4. The doping density of F4-TCNQ was set such that the density is 0.1% with respect to 2-TNATA at the center portion of the luminescent area, and decreases from the center portion toward the outer peripheral portion. The density was 0.02% at a corner of the outer peripheral portion of the luminescent area. In FIG. 4, 54 is a ITO substrate and 54 is a deposited layer.

On the thus obtained emittor, a liquid crystal shutter element having a pixel pitch of 0.1 mm was disposed. The emittor and the liquid crystal shutter element were connected to a driving section and a white solid image was displayed by switching R, G and B emission at a frame frequency of 60 Hz (i.e., the subframe period for each of R, G and G was 1/180 seconds). The whiteness was set such that the brightness balance of R, G and B was adjusted, the CIE chromaticity was (x, y)=(0.31, 0.32) at the center of the panel and the brightness was set to 200 cd/m². The CIE chromaticity and brightness were detected at a plurality of points in the planes, and it was found that the uniform CIE chromaticity was obtained across the panel . . . The brightness increases from the panel center portion toward outer peripheral portion of the panel, and was 215 cd/m² at the outer peripheral portion. The obtained field sequential liquid crystal display device had reduced brightness distribution compared with Example 1, and was of high quality without uneven color or uneven brightness.

### COMPARATIVE EXAMPLE

A luminescent section in which patterned R, G and B organic EL elements of R, G and B having the conventional luminescent area described FIG. 1 of 13 cm×15 cm are laminated was produced as a backlight for a field sequential liquid crystal display device in the following manner.

ITO was sputtered onto a glass substrate via a shadow mask for an anode to form an anode of predetermined pattern. The layer thickness of the ITO was 200 nm and the sheet resistance was 15 Ω/□. Then, Al was deposited onto the ITO as an auxiliary electrode through vacuum deposition via a shadow mask for an auxiliary electrode to a thickness of 100 nm as in Example 1. The pitch of the stripe opening of the shadow mask for the organic EL element was 0.36 mm and the opening width was 0.10 mm. Subsequently, the shadow mask for the organic EL element was shifted by 0.12 mm, and a layer of a green-emitting organic EL element as in Example 1 was formed. Then, the shadow mask for the organic EL element was further shifted by 0.12 mm, and a layer of blue-emitting organic EL element was formed. Finally, Al was deposited thereon as a cathode to a thickness of 100 nm via a shadow mask for a cathode (the pitch of the stripe opening of the shadow mask: 0.12 mm, the opening width: 0.08 mm).

On the thus obtained emittor, a liquid crystal shutter element having a pixel pitch of 0.1 mm was disposed. The emittor and the liquid crystal shutter element were connected to a driving section and a white solid image was displayed by switching R, G and B emission at a frame frequency of 60 Hz (i.e., the subframe period for each of R, G and G was 1/180 seconds). The whiteness was set such that the brightness balance of R, G and B was adjusted and the CIE chromaticity was (x, y)=(0.31, 0.32) at the center of the panel and the brightness was set to 200 cd/m². The CIE chromaticity and brightness were detected and found that the CIE chromaticity changes within the panel, and change amount (i.e., the difference between the maximum value and the minimum value) was Δx=0.22, and Δx=0.25. The brightness increases from the panel center portion toward outer peripheral portion of the panel, and was 340 cd/m² at the outer peripheral portion.

The present invention is useful for a display devices, especially a liquid crystal display devices.

The present invention is a display device comprising a luminescent section formed by laminating two or more organic electroluminescent elements that individually emit light, and a shutter section

The luminescent section is preferably formed by laminating red, green and blue luminescent organic EL elements. The shutter section is preferably a liquid crystal shutter element. The organic EL element is preferably driven in a field sequential system. Luminescent period of each organic EL element is preferably different from those of other elements. An upper electrode of one organic EL element preferably serves as a lower electrode of an organic EL element directly thereabove. The electrode preferably temporally switches between positive potential and negative potential. These aspects will provide a display device having simple configuration, thin profile or high quality.

Furthermore, a luminescent period of each of the organic electroluminescent elements is preferably in the range of from 1/150 to 1/300 seconds, and the luminescent section preferably comprises a transparent insulating layer between the two of the organic electroluminescent elements.

What is claimed is:

1. A display device comprising a luminescent section formed by laminating two or more organic electroluminescent elements that individually emit light, and a shutter section.

2. The display device according to claim 1, wherein the shutter section is a liquid crystal shutter element.

3. The display device according to claim 1, wherein the organic electroluminescent elements are driven by a field sequential system.

4. The display device according to claim 1, wherein a luminescent period of each to the organic electroluminescent elements are different from other organic electroluminescent elements.

5. The display device according to claim 1, wherein an upper electrode of one organic electroluminescent element serves as a lower electrode of an organic electroluminescent element directly thereabove.

6. The display device according to claim 5, wherein the electrode temporally switches between positive potential and negative potential.

7. The display device according to claim 1, wherein at least one of the organic electroluminescent elements includes an auxiliary electrode at at least one of outside of a luminescent area, inside of a luminescent area, and a boundary thereof.

8. The display device according to claim 1, wherein the layer thickness of the organic electroluminescent elements in an inner surface direction is substantially uniform, and local voltage-brightness characteristics of the organic electroluminescent elements are set to change toward the inner surface direction to make brightness within the surface uniform.

9. The display device according to claim 1, wherein the luminescent section is formed by laminating a red-emitting organic electroluminescent element, a green-emitting organic electroluminescent element and a blue-emitting organic electroluminescent element.

10. The display device according to claim 1, wherein a luminescent period of each of the organic electroluminescent elements is in the range of from 1/150 to 1/300 seconds.

11. The display device according to claim 1, wherein the luminescent section comprises a transparent insulating layer between the two of the organic electroluminescent elements.
